(19) United States
(12) Patent Application Publication
(10) Pub. No.: US 2014/0114632 A1
(43) Pub. Date: Apr. 24, 2014

(54) METHOD FOR MODELING A RESERVOIR USING 3D MULTIPLE-POINT SIMULATIONS WITH 2D TRAINING IMAGES

(71) Applicant: CONOCOPHILLIPS COMPANY, Houston, TX (US)

(72) Inventors: Jianbing WU, Anchorage, AK (US); Yongshe LIU, Katy, TX (US)

(73) Assignee: CONOCOPHILLIPS COMPANY, Houston, TX (US)

(21) Appl. No.: 14/056,637

(22) Filed: Oct. 17, 2013

Related U.S. Application Data
(60) Provisional application No. 61/716,050, filed on Oct. 19, 2012.

(51) Int. Cl. G01V 99/00

(52) U.S. Cl. CPC G01V 99/005
USPC 703/10

(57) ABSTRACT

A method for modeling a reservoir is described. One example of a method for modeling a 3D reservoir involves using multiple-point simulations with 2D training images.

### CROSS-REFERENCE TO RELATED APPLICATIONS

This application is a non-provisional application which claims benefit under 35 USC §119(e) to U.S. Provisional Application Ser. No. 61/716,050 filed Oct. 19, 2012, entitled “METHOD FOR MODELING A RESERVOIR USING 3D MULTIPLE-POINT SIMULATIONS WITH 2D TRAINING IMAGES,” which is incorporated herein in its entirety.

### FIELD OF THE INVENTION

This invention relates to a method for modeling a reservoir. More particularly, a method for modeling a 3D reservoir using multiple-point simulations with 2D training images.

### BACKGROUND OF THE INVENTION

In the oil and gas industry, flow simulations are widely used for predicting the reservoir performance, which in many cases is controlled by the distribution of reservoir properties, such as facies, porosity and permeability.

The variogram-based algorithms, e.g., SGSIM (Sequential Gaussian Simulation) and SISIM (Sequential Indicator Simulation), generate petrophysical distributions pixel-by-pixel through a prior variogram model accounting for the spatial continuity and are able to condition various types of data, such as well data, 2D or 3D trend information (Goovearts, 1997; Deutsch and Journel, 1998; Remy et al., 2009). However, these algorithms only reproduce up to 2-point statistics, histogram and variogram, which are not sufficient to generate complex geological features, such as lobes and channels.

The object-based or the Boolean algorithms (Haldorsen and Chang, 1986; Lantuejoul, 2002; Maharaja, 2008) can produce better geological patterns by dropping whole objects of given shapes into the simulation grid. These algorithms parameterize the objects according to the shape, size, anisotropy, sinuosity, and the interaction (erosion and overlap) with other objects. In order to match the desired facies proportions and to honor the conditioning data, an iterative process is utilized to remove, replace, and transform the previously dropped objects. However, the iterative process creates issues when the well spacing is smaller than the object size. This situation gets worse with dense wells, 2D or 3D soft data, and other exhaustive information.

The weakness of both variogram-based and object-based algorithms triggered the concept of multiple-point geostatistical simulations (mps) (Journel, 1992). With mps, the simulation proceeds pixel-wise along a random path which visits all the simulation nodes. Instead of borrowing statistics from a prior variogram model, the local conditional probabilities in mps are lifted as conditional proportions from a given training image (TI). The training image is a geological concept model depicting geological patterns such as the geometry, texture and distribution of objects deemed to prevail in the real world.

The SNESIM (Single Normal Equation Simulation) is the first practical mps algorithm developed to handle the categorical variables, such as lithofacies (Strebelle, 2000). Later, the FILTERSIM (Filter-based Simulation) algorithm was utilized to simulate the distribution of continuous variables, such as porosity and permeability (Zhang 2006).

In order to perform mps simulation to generate a 3D geological property, a 3D training image is required. Practically, the TI is obtained from outcrops, air photos, or even brush-painted by geologists, which are normally in 2D. How to generate a 3D TI with a 2D map and how to simulate 3D mps models from a 2D TI become challenging for geoscientists.

How to reconstitute a 3D structure from a 2D map is a topic of interest in various areas, such as image processing, material engineering, rock physics, and petroleum engineering. A number of methods have been proposed, which can be categorized into four groups: simple stack, statistics-based, process-based and mps-based.

The simple stack method combines a series of 2D sections into a 3D image. These 2D sections can be obtained directly from laboratory photographs (Dullien, 1992; Tomutsa and Radmilovic, 2003) or from X-ray computed tomography pictures (Dunsmuir et al., 1991; Fredrich 1999). In general, these methods require laborious operations and are very time consuming, hence are not suitable for the routine applications.

The statistics-based techniques describe the 3D models with some statistical measure, for instance the histogram and the 2-point correction functions. The statistics-based techniques then reconstruct the 2D model with respect to the statistical measures using stochastic procedures, such as simulated annealing (Yeong and Torquato, 1998), truncated Gaussian simulation (Biswal and Hilfer, 1999), and percolation system (Daian et al., 2004). The statistical measures could come from some empirical relations (Ioannidis et al., 1996) or be derived from a known 2D image (Quiblier, 1984). The main drawback with the statistics-based technique is the difficulty to reproduce the long range connectivity of interested variables.

The process-based algorithms reconstruct 3D porous medium by modeling its geological process (Bryant and Blunt, 1992; Biswal et al., 1999; Pilotti, 2000). This method is capable of reproducing long range connectivity for certain geological systems. However, process-based algorithms encounter difficulties when the sedimentation process becomes complex and/or involved irregular object shapes, for example the carbonate system. Moreover, the process-based training image is not stationary for mps simulation

In recent years, the mps algorithm for 3D image constructions using 2D maps as the input training images have been utilized. Okabe and Blunt (2005) proposed a method to use SNESIM algorithm for pore space reconstruction. Assuming the porous medium is isotropic, a 2D section image is used to provide the pore space patter in each X/Y/Z direction during the SNESIM simulations. Zhang et al. (2008, 2009) proposed another way to use the SNESIM algorithm for generating 3D pore space images. In this method, each horizontal layer is simulated in sequence. After simulation of one layer is complete, the training image is replaced with the simulation in that layer. Data is sampled with a predetermined template from the training image to the next simulation later. Finally, the SNESIM simulation is performed with the new TI and the sampled hard data. The newly proposed mps-based method can reproduce long range connectivity, but is exempted from the prior knowledge of geological process.

All of the methods discussed above focus on the micro scale, such as the 3D porous medium structure and material microstructures. Therefore, a need exists for a macro scale mps algorithm to generate 3D reservoir distributions (facies, porosity, permeability) with 2D training images.

### SUMMARY OF THE INVENTION

In an embodiment, a method for modeling a reservoir includes: receiving and loading data; creating a 3D grid with a plurality of layers; generating a 2D grid for each layer in sequence; reconstructing or simulating a 2D image for the first layer; sampling data from the 2D image on the first layer; sampling data from the 2D grid for all other layers; setting sampled data as hard data; performing a filter based simulation to condition the hard data; and copying the filter based simulation from the 2D grid to the 3D grid.

In another embodiment, a method for modeling a reservoir includes: receiving and loading data; creating a 3D grid with a plurality of layers; generating a 2D grid for each layer in sequence; getting target facies proportions; sampling the data from the 2D grid, wherein the sampling is a point sampling, a geobody sampling or a hybrid sampling; performing a single normal equation simulation to condition the data; and copying the SNESIM based simulation from the 2D grid to the 3D grid.

### BRIEF DESCRIPTION OF THE DRAWINGS

The invention, together with further advantages thereof, may best be understood by reference to the following description taken in conjunction with the accompanying drawings in which:

FIGS. 1(a)-1(c) show various images according to one embodiment of the invention: (a) 2D training image; (b) good 3D training image; (c) poor 3D training image.

FIG. 2 depicts a 2D continuous training image, according to an embodiment of the invention.

FIGS. 3(a)-3(b) depict a final 3D realization with random sampling, according to an embodiment of the invention: (a) original 3D realization; (b) de-noised realization.

FIGS. 4(a)-4(d) depict hard samples for data conditioning and simulated realization, according to an embodiment of the invention: (a) hard data sampled from layer 1; (b) 2D realization in layer 2; (c) hard data sampled from layer 2; (d) 2D realization in layer 3.

FIG. 5 depicts a realization simulated directly with a 2D training image, according to an embodiment of the invention.

FIGS. 6(a)-6(b) depict a final 3D realization with histogram-based sampling, according to an embodiment of the invention: (a) original 3D realization; (b) de-noised realization.

FIGS. 7(a)-7(b) depict realizations with random sampling option and data mutations, according to an embodiment of the invention: (a) no mutation; (b) mutate 20% samples; (c) mutate 30% samples; (d) mutate 40% samples.

FIGS. 8(a)-8(d) depict realizations with random sampling option, according to an embodiment of the invention: (a) 100 samples; (b) 200 samples; (c) 300 samples; (d) 400 samples.

FIG. 9 depicts a realization simulated directly with a 2D training image, according to an embodiment of the invention.

FIGS. 10(a)-10(b) depict realizations with regular grid sampling and data mutations, according to an embodiment of the invention: (a) no mutation; (b) mutate 30% samples.

FIGS. 11(a)-11(e) depict testing geobody sampling with two facies training image, according to an embodiment of the invention.

FIG. 12 depicts geobodies exampling with three facies images, according to an embodiment of the invention.

FIGS. 13(a)-13(b) depict a final 3D realization and one realization simulated directly with the given 2D two facies training image according to an embodiment of the invention: (a) realization with new workflow; (b) direct simulation with 2D TI.

FIG. 14 depicts a 2D three facies training image, according to an embodiment of the invention.

FIGS. 15(a)-15(d) depict three final 3D realizations and one realization simulated directly with the given 2D three facies training image, according to an embodiment of the invention: (a) realization #1 with new workflow; (b) realization #2 with new workflow; (c) realization #3 with new workflow; (d) direct simulation with 2D TI.

FIG. 16 depicts a 2D four facies training image, according to an embodiment of the invention.

FIGS. 17(a)-17(b) depict a final 3D realization and one realization simulated directly with the given 2D four facies training image, according to an embodiment of the invention: (a) realization with new workflow; (b) direct simulation with 2D TI.

FIG. 18 depicts a workflow for a FILTERSIM continuous simulation with a 2D training image, according to an embodiment of the invention.

FIG. 19 depicts a workflow for SNESIM categorical simulation with a 2D training image, according to an embodiment of the invention.

FIG. 20 depicts a workflow for point sampling, according to an embodiment of the invention.

FIG. 21 depicts a workflow for geobody sampling, according to an embodiment of the invention.

FIG. 22 depicts a workflow for hybrid sampling, according to an embodiment of the invention.

FIG. 23 depicts a workflow for sampling facies geobodies, according to an embodiment of the invention.

### DETAILED DESCRIPTION OF THE INVENTION

Reference will now be made in detail to embodiments of the present invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used in another embodiment to yield a still further embodiment. Thus, it is intended that the present invention cover such modifications and variations that come within the scope of the appended claims and their equivalents.

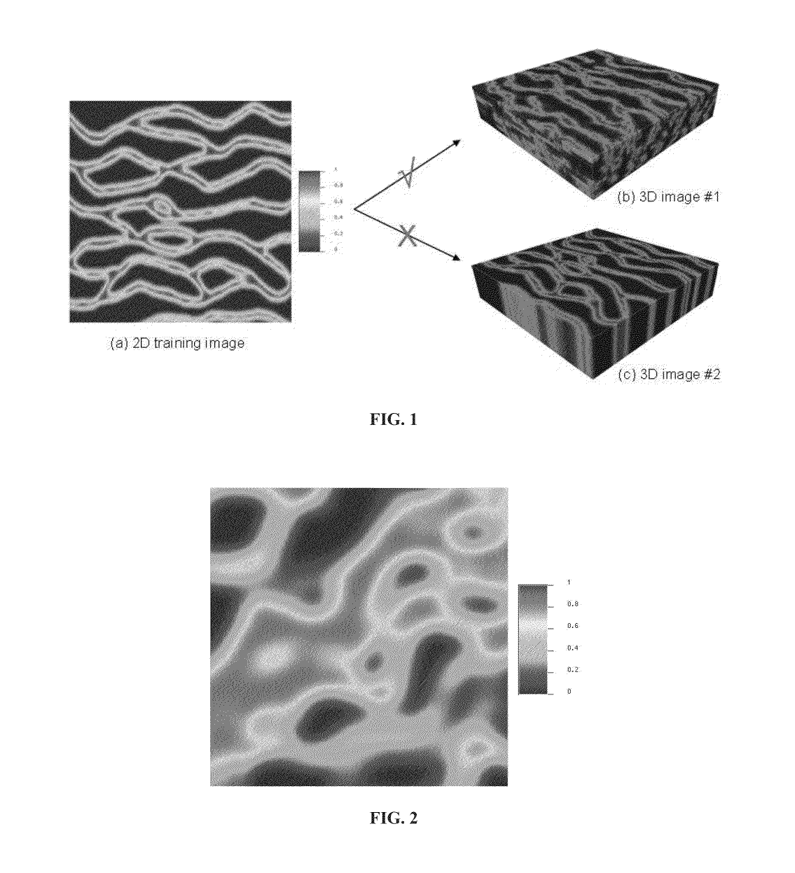

The present invention focuses on a method to use the FILTERSIM algorithm for 3D continuous variable simulations using a 2D training image (TI) and a method for the use of the SNESIM algorithm to simulate 3D categorical facies with a 2D TI. The resulted 3D image should reproduce the geological features from the given 2D TI; should have reasonably good vertical continuities; and should have reasonably good vertical variations. For example, FIG. 1(b) is a good 3D image constructed from FIG. 1(a) which is a 2D training image; while FIG. 1(c) is not, which is simply a pile of 2D images.

### FILTERSIM Continuous Simulation

The FILTERSIM algorithm (Zhang, 2006) first extracts all of the patterns from the given training image (TI) using a predefined template. As previously discussed, the training image is a geological concept model depicting geological patterns. The geological patterns are then grouped into different classes based on the filters. Finally the algorithm performs stochastic simulation using pattern recognition techniques. The simulated realization can be conditioned to various types of data, such as well hard data, soft probability or trend data, and azimuth and scaling factors. In general, the FILTERSIM algorithm requires a 3D TI for 3D simulations.

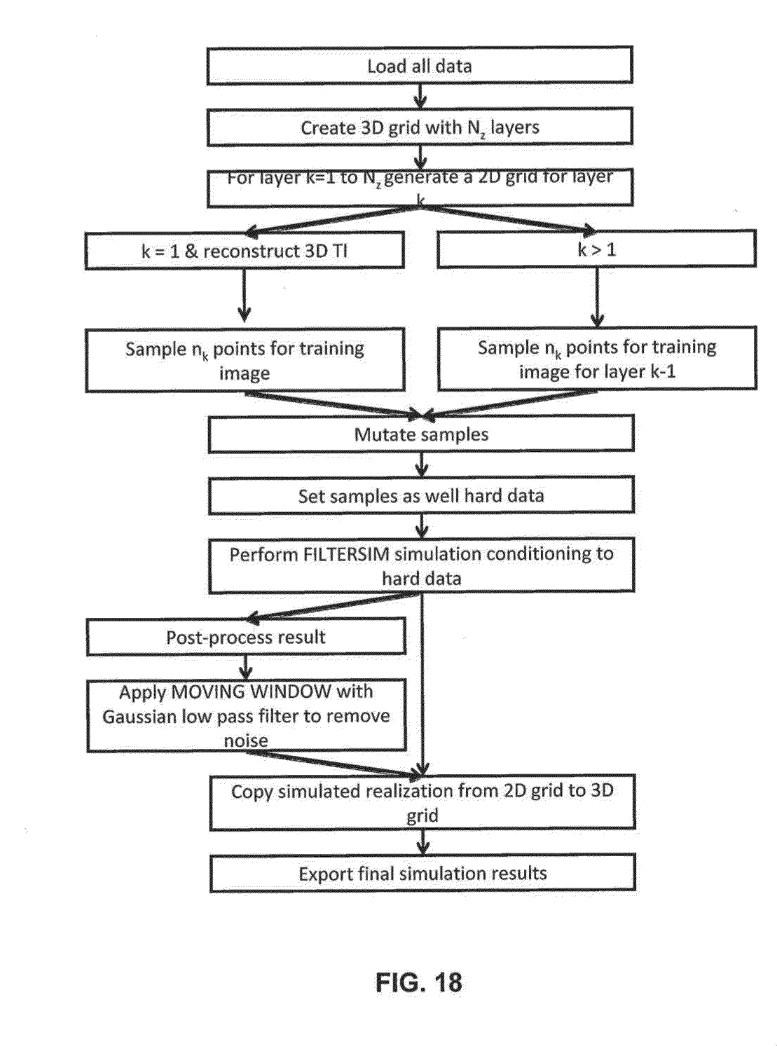

The method for 3D multiple point simulation uses 2D training images to simulate continuous variables with the FILTERSIM algorithm, shown in FIG. 18, in a 3D grid (G) of size

Nₓ×N_{y}×N_{z}. The method can also be used to construct a 3D TI from any 2D maps, in that sense the size of the 2D TI must be Nₓ×N_{y}.

The method processes the 3D grid (G) from layer 1 to layer N_{z} in sequence. At each layer k ∈[1, N_{z}], a 2D simulation grid Gₖ (of size Nₓ×N_{y}) can be created and be used as the host for running the FILTERSIM simulation.

For the first layer (k=1), if the purpose of simulation is to reconstruct a 3D TI, then sample data (nₖ) from the given the TI is sampled, saved as hard data and run in the FILTERSIM simulation conditioning to the nₖ samples; otherwise, unconditional FILTERSIM simulations are run. For the remaining layers k ∈[2, N_{z}], first sample data (nₖ) data from the 2D grid Gₖ₋₁, save the samples as hard data in layer k, and then run the FILTERSIM simulation conditioning the nₖ new samples. The simulated realization in grid Gₖ can be post-processed to remove the simulation noise, for example using the Gaussian low pass filter. Finally, copy all temporary 2D simulations from grids Gₖ (k=1,2, . . . , N_{z}) to the 3D grid G to form a full 3D realization.

For the data sampling, various strategies can be applied, such as (1) fully random sampling, which does not consider the data values and patterns; (2) regular grid sampling, which samples every Nᵣ^{x}, Nᵣ^{y} node in the X, Y direction, respectively; (3) stratified sampling, which divides the grid into N_{w} windows and randomly select nₖ/N_{w} nodes from each window; or (4) histogram-based sampling, which divides the histogram into Nᵢₙₜ intervals and then randomly samples nₖ/Nᵢₙₜ nodes for each interval.

If no vertical trend curve exists, then there is no preference as to which sampling algorithm is selected. However, when a vertical portion/mean curve exists, the histogram-based sampling is recommended. With the histogram-based sampling, nodes close to corresponding values from the vertical curve and sampled. The sampled hard data should be combined with the original user-supplied hard data to constrain FILTERSIM simulations.

Because the process borrows some conditioning data from the adjacent layer, some vertical continuity's between two successive layers are ensured. And because of the nature of stochastic simulation, there will be some variations between these two layers. However, when the number of sampled hard data becomes larger, the difference between two successive layers will get smaller. A certain portion of the sampled data should be mutated to allow for larger vertical variations. The operation can be data location shifting, data value modification, node dropout, or any combination thereof.

### EXAMPLE

FIG. 2 shows a 2D continuous training image of size 150×150, which represents a probability field with the high values elongated from the lower-left corner to the upper-right corner. The size of the 3D simulation grid is 150×150×10. Each 2D simulation was run with an 11×11 search template and a 7×7 patch template. The number of nodes sampled was nₖ=200.

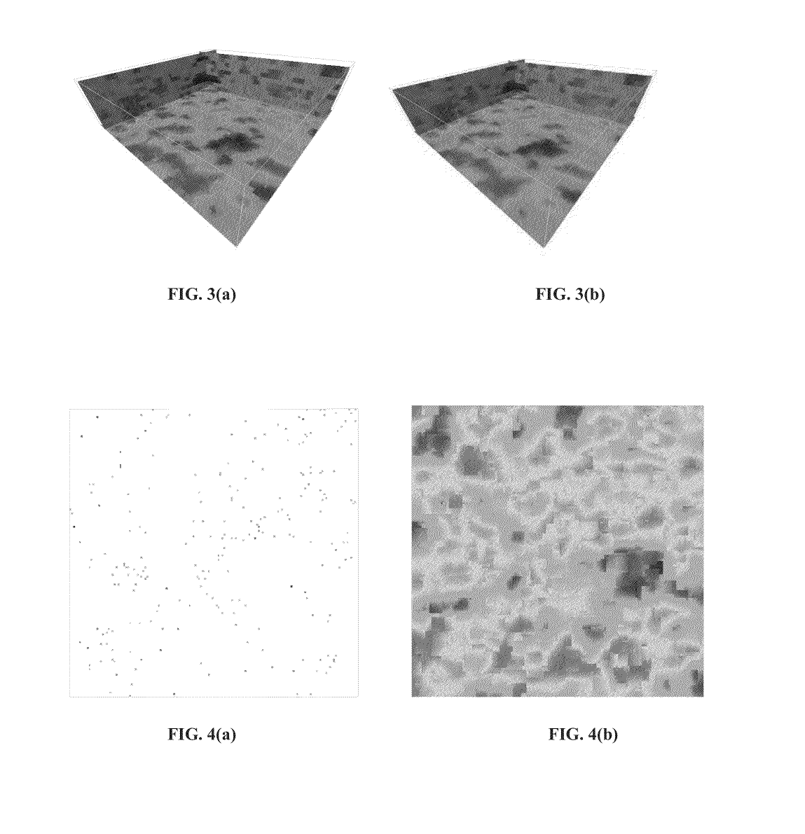

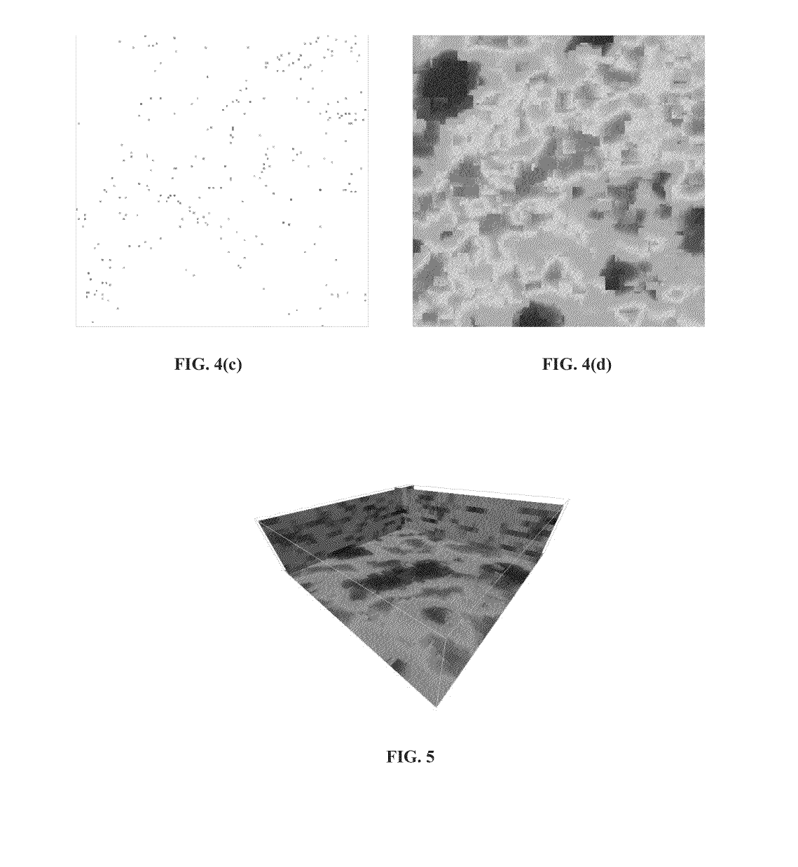

FIG. 3(a) gives one final 3D realization with random sampling option and FIG. 3(b) shows the corresponding de-noised 3D image. The sampled hard data and the 2D FILTERSIM simulation in layers 2 and 3 are shown in FIGS. 4(a)-4(d). These figures show vertical continuities with some variations from one layer to the next. For comparison, the direction FILTERSIM simulation with the 2D training image is given in FIG. 5, which depicts the layering effects with poor vertical continuities.

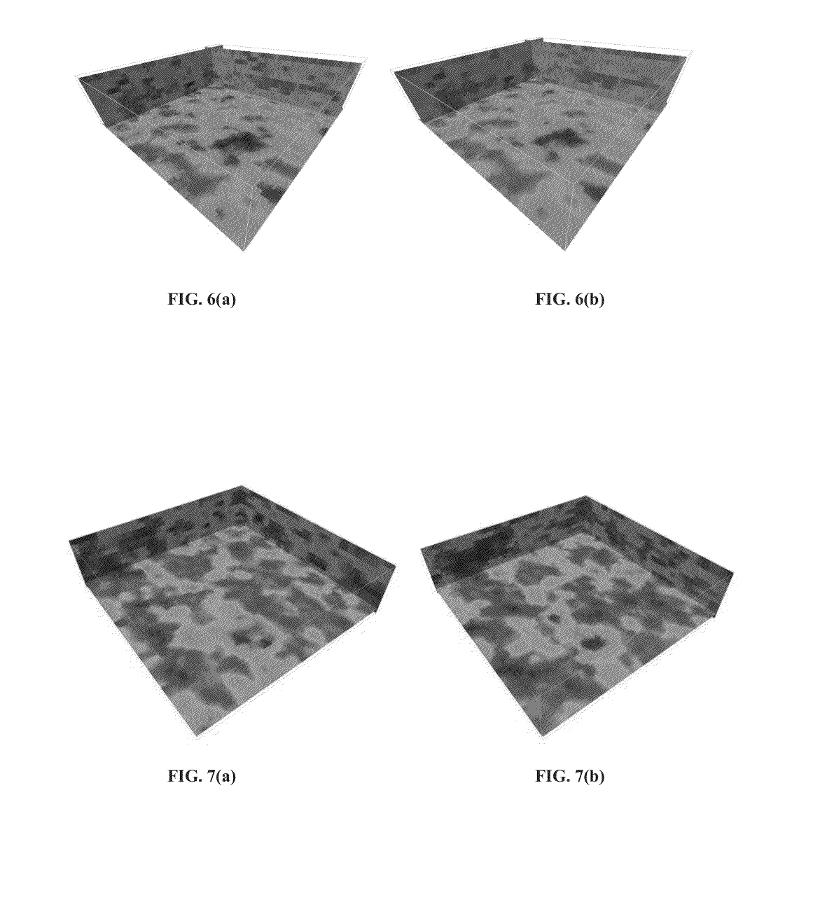

Next, a vertical target mean curve was used to constrain the average probability for each layer. The input target means are shown in Table 1. FIG. 6 shows one final 3D realization with vertical constraints with layering means values provided in Table 1. For comparison, Table 1 also gives the statistics for the simulation with the random sampling option and some vertical curve constraint, which results in a poorer reproduction of the layer averaging values.

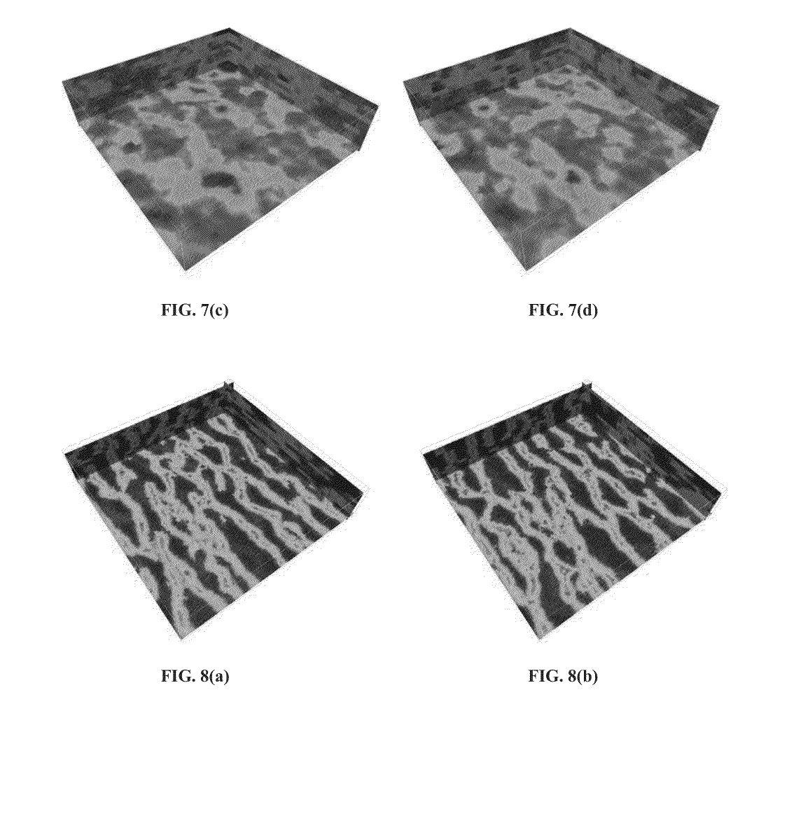

From FIGS. 3(b) and 6(b), the method produces vertical connectivity in the 3D realizations, while still preserving some variations between two successive layers. However, when the number of samples is increased to nₖ=400, the vertical variations become less observable, see FIG. 7(a) for the ten-layer thick continuous high value pattern in the back slice. To maintain some vertical variations, the data mutation concept can be applied. FIG. 7 gives three such realizations by shifting the sampled data locations, which shows the more the number of samples mutated then the more significant the vertical layer variations.

TABLE 1
Average Values of each Layer

| Layer # | Input Vertical Curve | Histogram Sampling | Random Sampling |
|---|---|---|---|
| 1 | 0.600 | 0.535 | 0.535 |
| 2 | 0.650 | 0.628 | 0.560 |
| 3 | 0.700 | 0.648 | 0.531 |
| 4 | 0.750 | 0.645 | 0.554 |
| 5 | 0.700 | 0.670 | 0.558 |
| 6 | 0.600 | 0.605 | 0.565 |
| 7 | 0.500 | 0.492 | 0.535 |
| 8 | 0.400 | 0.454 | 0.447 |
| 9 | 0.600 | 0.537 | 0.493 |
| 10 | 0.700 | 0.635 | 0.582 |

### EXAMPLE

FIG. 1(a) shows a 2D training image, in which the property values accumulate high along the channel centers and decreases gradually to zero towards the channel edges. The size of the training image is 240×240.

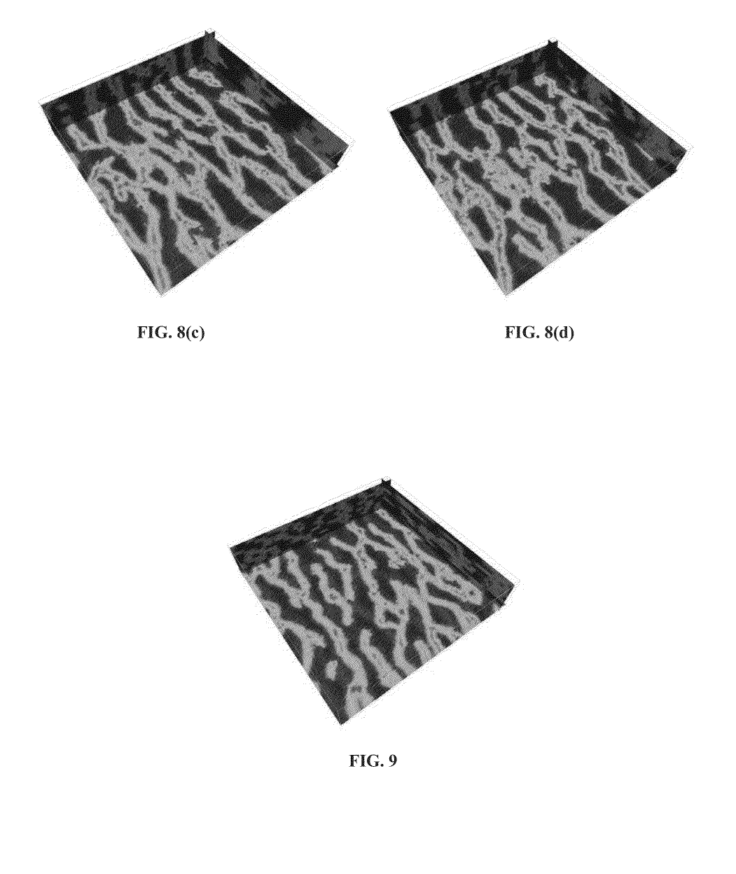

The 2D training image was used to construct a 3D training image of size 240×240×10. FILTERSIM was run with a 17×17 search template and a 5×5 patch template. FIG. 8 gives four reconstructed 3D training images using the random sampling method and with a different number of hard samples. In general, the more nodes sampled, the better the vertical continuity. For comparison, FIG. 9 shows direct FILTERSIM simulation with the given 2D TI.

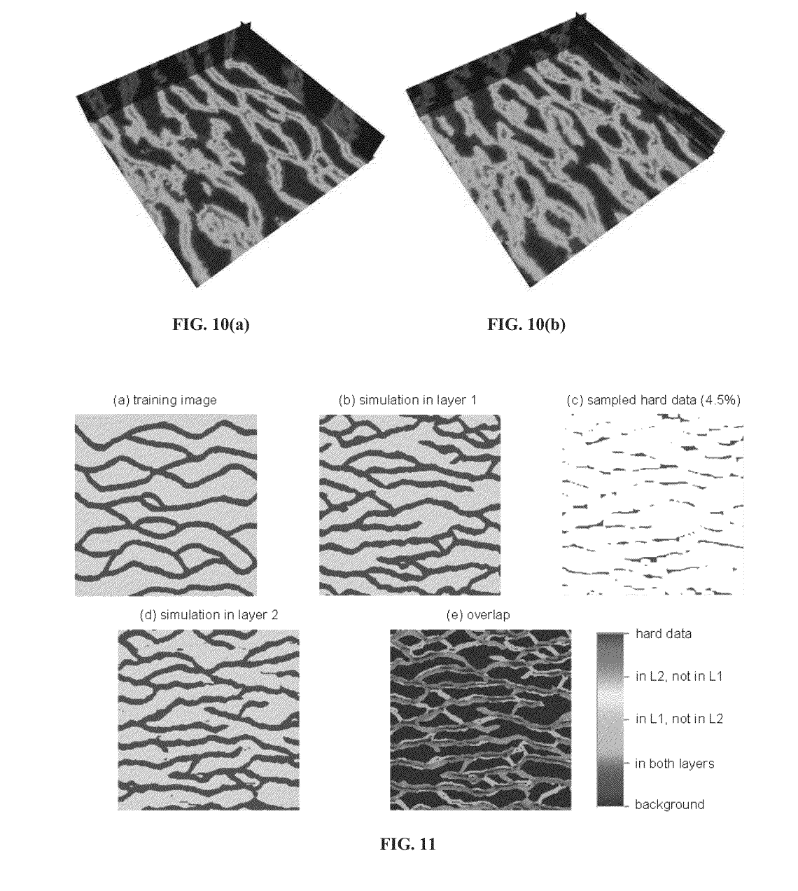

Next, the method was tested with the mutation concept. FIG. 10(a) shows the reconstructed 3D image without mutation by sampling every eight nodes in the X/Y directions. The dimension of this image is almost 2.5D, with the channels having the same 10-layer thickness. By mutating 30% of the samples, the constructed 3D image, as shown in FIG. 10(b), has more vertical variations with the channels exhibiting different thickness.

### SNESIM Categorical Simulation

The SNESIM algorithm (Strebelle, 2000) first scans the given TI for all possible patterns with a predefined search template and saves the scanned local simulation proportions into a search tree data structure. During simulation, the same search template is used to look for the local conditioning data in the simulation grid and its corresponding conditional probability. Similar to the FILTERSIM algorithm, it is not recommend to perform SNESIM simulations with a 2D TI.

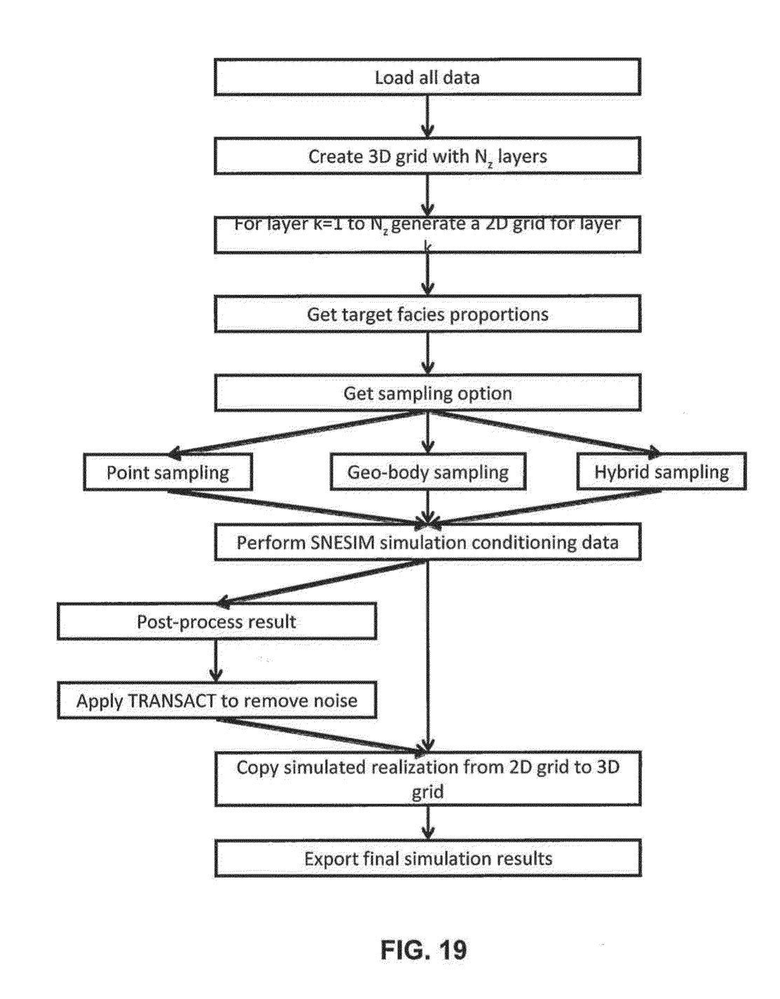

The method uses 2D training images to simulate categorical variables with the SNESIM algorithm, shown in FIG. 19, in a 3D grid (G) of size Nₓ×N_{y}×N_{z}. Moreover, the method can be used to reconstruct a 3D TI from any 2D maps, for this purpose the size of the 2D TI should be Nₓ×N_{y}.

The workflow processes the 3D grid (G) from layer 1 to layer N_{z} in sequence. At each layer k ∈[1, N_{z}], a 2D simulation grid (Gₖ) of size Nₓ×N_{y} should be created and will be used as the host for running the SNESIM simulation. For each layer, the target facies proportions can be the same as the global target, if there are no vertical proportion curves; otherwise, target facies proportions are derived from vertical proportion curves.

For the first layer (k=1), if the purpose of simulation is to reconstruct a 3D TI, then sample nₖ data from the given TI is sampled and the SNESIM simulation conditioning to the nₖ samples is run; otherwise, unconditional SNESIM simulations are run. For the remaining layers k(>1), first sample nₖ data from the 2D grid and then run the SNESIM simulation conditioning to the nₖ new samples. The simulated realization in grid Gₖ can be post-processed to remove the simulation noise. Finally, copy all temporary 2D simulations from grids Gₖ (k=1,2, . . . N_{z}) to the 3D grid G to constitute a full 3D realization.

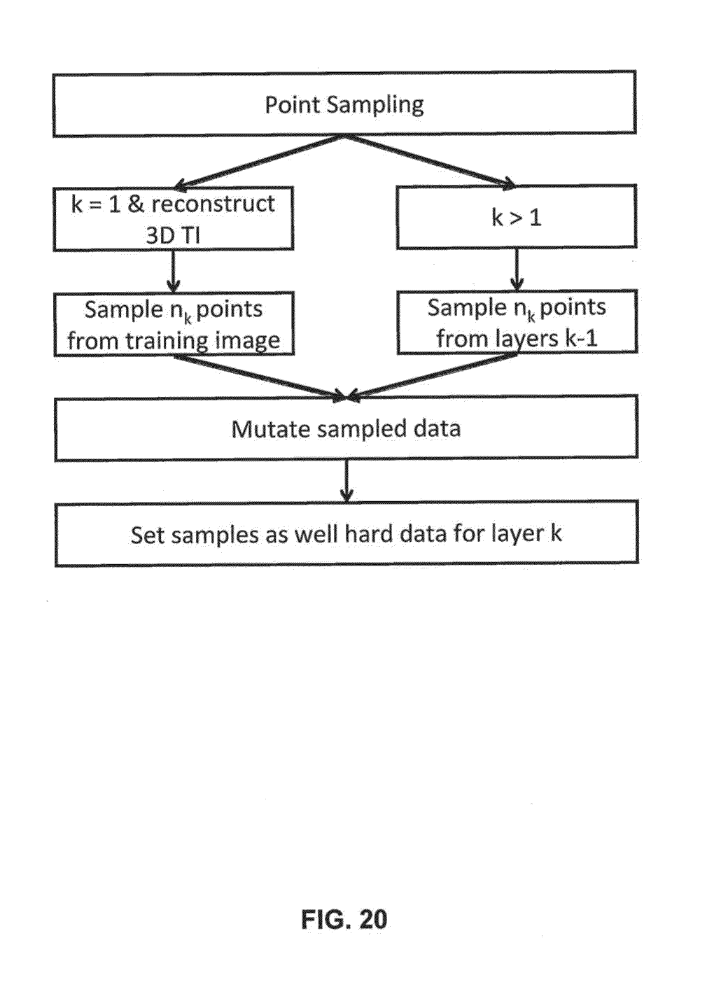

Three methods are presented for data sampling: point sampling, geo-body sampling and hybrid sampling. The point sampling method, shown in FIG. 20, samples some isolated points from a given 2D map, either the input training image or a previously simulated 2D realization. The sample points are well hard data. The number of samples is nₖ.

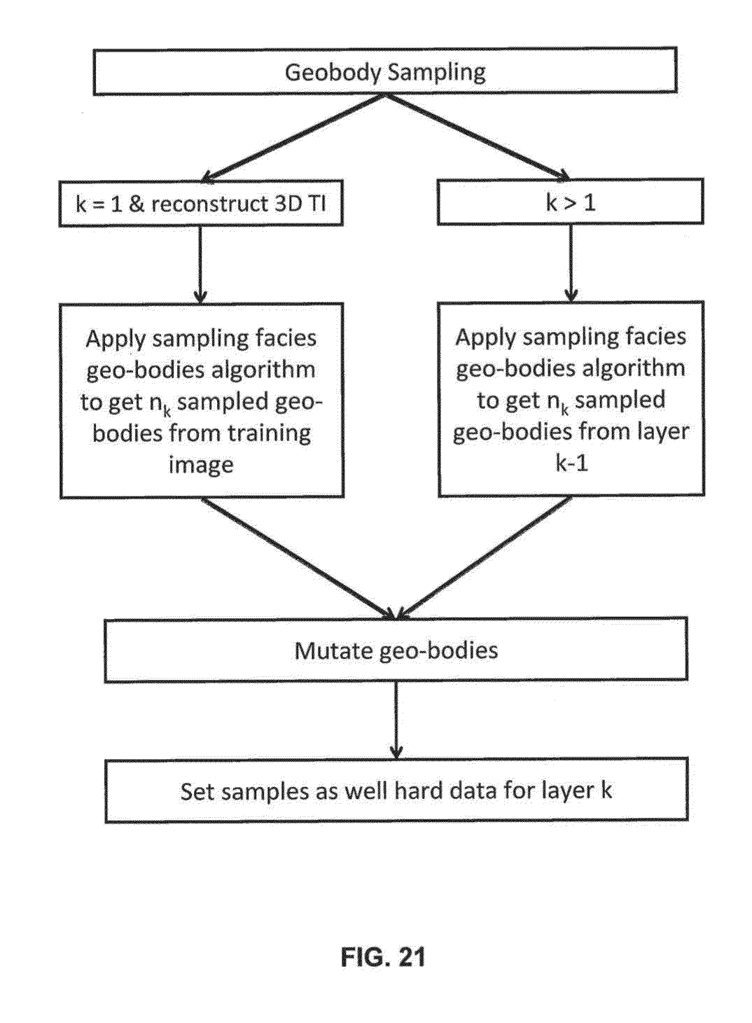

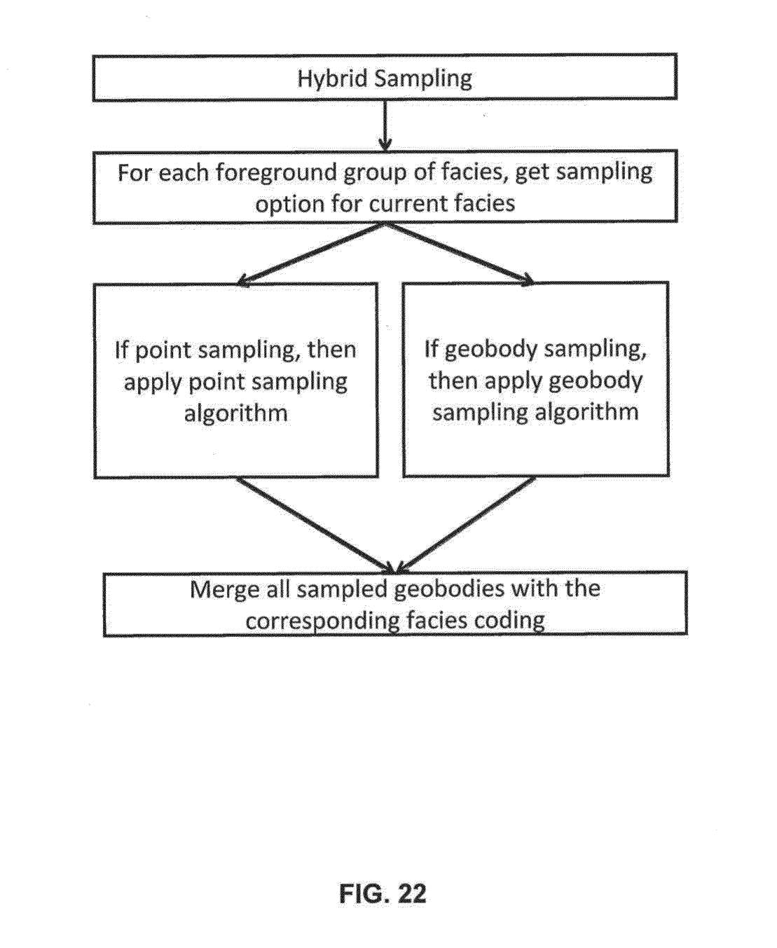

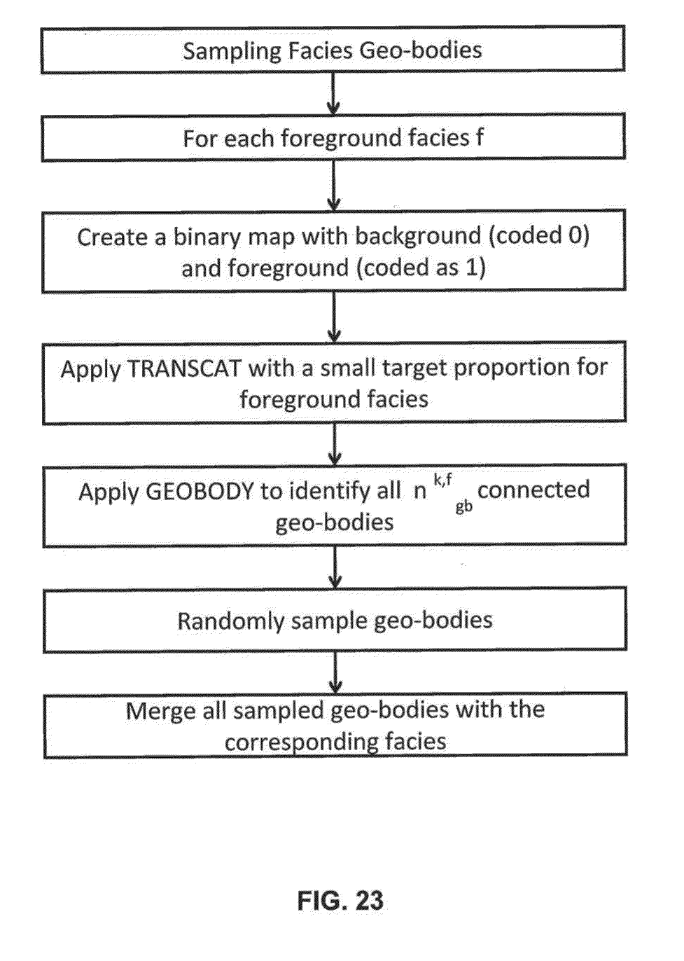

The geobody sampling method, shown in FIGS. 21 and 22, selects connected cells as geo-bodies from a given 2D image. For each foreground facies (f) a binary map Z_{f} with the background facies (coded as 0) and the foreground facies f (coded as 1) created, with the latter forming some connected geo-objects GB_{f}. Then apply the TRANSCAT algorithm (Remy et al., 2009) on Z_{f} with a small target proportion of facies (f) to encode the connected foreground objects GB_{f} into disconnected segments as the central locations of GB_{f}. Finally, all n_{gb}^{k,f} geobodies are identified for those segments and sample nₖ^{f}(≦n_{gb}^{k,f}) geobodies, which allow for variations between two successive layers. The sampled geo-bodies can be merged into nₖ number of geo-bodies with the corresponding facies coding and set as the simulated regions for data conditioning.

The hybrid method, shown in FIG. 22, uses either the point sampling method or the geo-body sampling method to sample each foreground facies, according to their specific settings. The sampled points can be set as well data and sampled geo-bodies can be set as the simulated regions for data conditioning. All the sampled data should be combined with the original user-supplied hard data to constrain SNESIM simulations.

As previously discussed, the conditioning can either be well hard data or region data. Because well data allows for data relocation, the point sampling method sets the sample as well data for better conditioning. However, data relocation is less important with sampled geo-bodies, because multiple cells (with the same value) from a single geo-body may be relocated to the same simulation node. Hence, the geo-body sampling method relies on the region concept to provide conditioning data.

Point sampling works well to supply the sparse hard conditioning data to maintain the vertical connectivity's with reasonable vertical variations. However, with geo-body sampling the sampled hard data will be clustered as a set of connected geo-objects, which are normally dense. One concern with geobody sampling is whether or not there will be enough variations between two successive layers.

FIG. 11(a) is a 2D two facies categorical training image representing fluvial channels; FIG. 11(b) shows one 2D SNESIM realization in layer one using FIG. 11(a) as the training image; FIG. 11(c) is the sampled geobodies from FIG. 11(b), accounting for 4.5% nodes; FIG. 11(d) is the SNESIM realization in layer two conditioning to the hard data in FIG. 11(c); and FIG. 11(e) is the overlap of two realizations. FIG. 11(e) clearly depicts that there are good vertical connections for some channels, and there are also some variations for other channels.

Due to the current design of mps algorithms, it is difficult to reproduce long range channel continuities even with a very large search template for 3D mps simulations. However, FIGS. 11(b) and 11(d) show good long range connectivity structures.

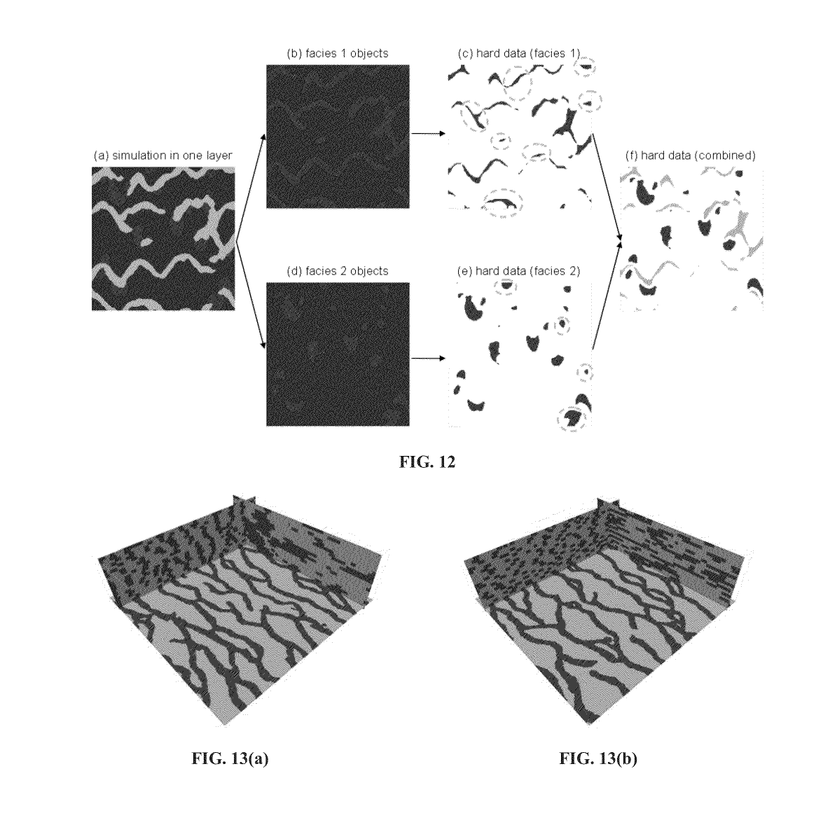

FIG. 12 demonstrates the process to generate the geobody samples for a three facies image. FIGS. 12(b) and 12(d) are the two binary images displaying the geo-objects for each foreground facies. FIGS. 12(c) and 12(e) illustrate the central locations of the geo-objects in the binary images. The final geo-body samples are given in FIG. 12(f), which will be used as conditioning data for the simulation in the next layer. Note, the large geobodies in FIG. 12(e) could be further narrowed down by optimizing the TRANSCAT parameters.

### Example

The 2D two facies channelized training image shown in FIG. 11(a) was used to construct a 3D image of size 250×250×20, with a global target proportion of 0.3 for the same channels facies. Each 2D SNESIM simulation was run with a radial search template containing 80 nodes and three multiple grids. During the simulation, ⅓ of the identified geo-bodies were removed from the conditioning data list.

One final 3D realization using the method sown in FIG. 13(a), which shows good vertical connectivity's for the channel facies. Additionally, there are some variations from one layer to another, noticing the channel thickness varies from location to location over the 20 layer grid. FIG. 13(b) gives one SNESIM realization simulated directly with the 2D TI, from which one can see the obvious layering effect, being short of vertical continuities.

### Example

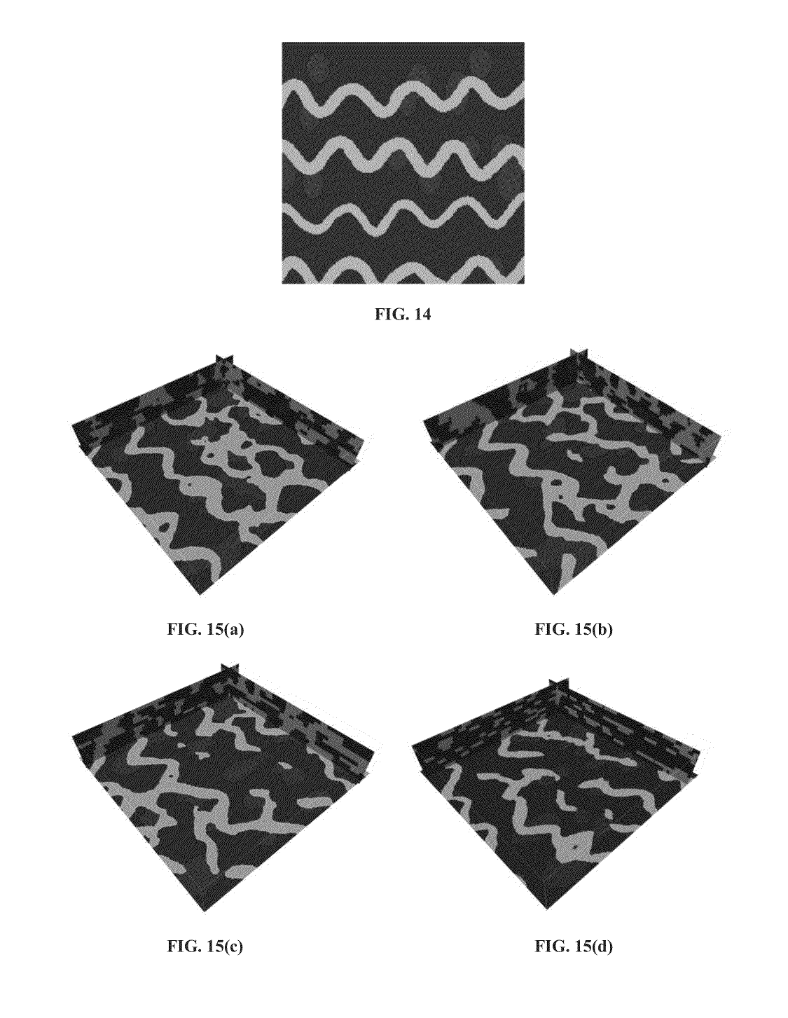

A three facies training image (of size 200×200) is shown in FIG. 14, which represents a channel system with ellipse drops. The target proportion for the channel and the ellipse facies are 0.25 and 0.10, respectively. The simulation grid has the same areal size as the TI but having only 10 layers. Each 2D SNESIM simulation was run with a radial search template containing 60 nodes and five multiple grids. During the simulation, ⅓ of the identified geo-bodies were removed from the conditioning data list.

FIG. 15 gives three 3D images generated with the method and one realization simulated directly using the 2D TI. In FIG. 15, plots (a), (b) and (c) show both the channels and ellipses are connected reasonably well from one layer to another, while plot (d) shows the string layering effect, hence the poor vertical connectivity's.

### Example

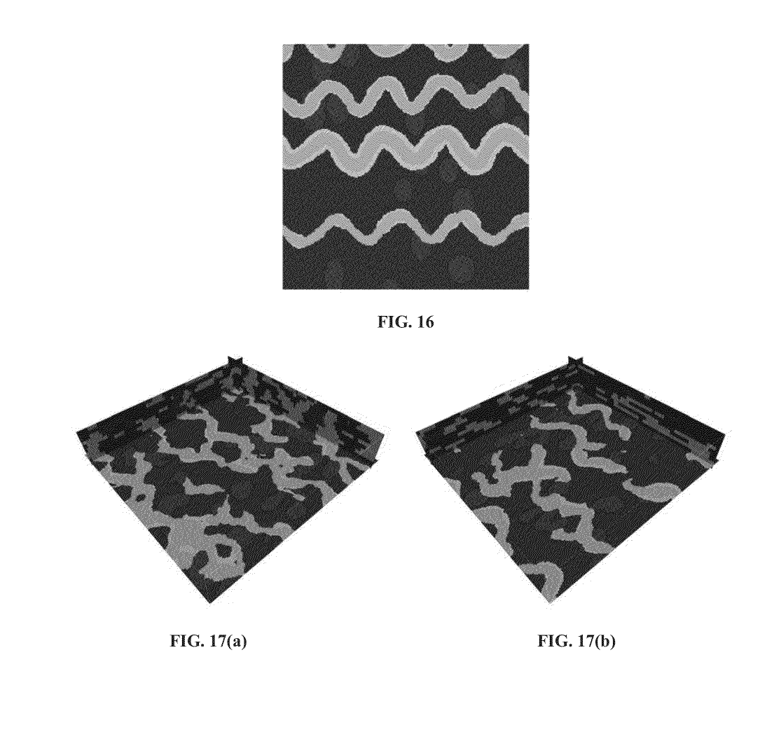

A four facies training image in FIG. 16 was used to simulate the distribution of channels, levees and ellipse drops in the mud background. The simulation grid was 200×200×10 in size. Each 2D SNESIM simulation was run with a radial search template containing 60 nodes and five multiple grids. During the simulation, ⅓ of the identified geo-bodies were removed from the conditioning data list.

One final 3D realization using the method is depicted in FIG. 17(a), which shows good vertical connectivity's for all foreground facies with some variations from one layer to another as seen from the different thicknesses of the geo-objects. For comparison, FIG. 17(b) gives one SNESIM realization simulated directly with the 2D TI, which depicts the strong layering effect as seen from the poor vertical continuities of the simulated geo-objects.

### Variables

G=3D grid

N=cell dimension

k=layer index

n=number of sample

r=regular grid

int=interval

w=windows

GB=geobody

Z=binary map

f=facies

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### References

The discussion of any reference is not an admission that it is prior art to the present invention, especially any reference that may have a publication data after the priority date of this application.
1. Biswal, B. and Hilfer, R.: 1999, Microstructure analysis of reconstructed porous media, Physica A 722, 307-311.
2. Biswal, B. et al., 1999, Quantitative analysis of experimental and synthetic microstructures for sedimentary rock, Physica A 273, 452-475.
3. Bryant, S. and Blunt, M.: 1992, Prediction of relative permeability in simple porous media, Physical Review A 46(4), 2004-2011.
4. Darian, J. et al.: 2004 3d reconstitution of porous media from image processing data using a multiscale percolation system, Journal of Petroleum Science & Engineering 42, 15-18.
5. Deutsch, C. V. and Journel, A. G.: 1998 GSLIB: Geostatistical software library and user's guide 2^{nd} edition, Oxford University Press, New York.
6. Dullien, F.: 1992, Porous media: fluid transport and pore structure, America Press.
7. Dunsmuir, J. et al.” 1991, X-ray microtomography: a new tool for the characterization of porous media, Proceeding of Annual Technical Conference, Dallas, Tex., pp. 421-430. SPE paper 22860.
8. Fredrich, J.: 1999, 3d imaging of porous media using laser scanning confocal microscopy with application to microscale transport process, Physics and Chemistry of the Earth. Part A: Solid Earth and Geodesy 24(7), 551-561.
9. Goovaerts, P.: Geostatistics for natural resources evaluation, Oxford University Press, New York.
10. Haldorsen, H. H. and Chang, D. M.: 1986, Note on stochastic shales: from outcrop to simulation model, in L. Lake and H. Caroll (eds), Reservoir characterization, Academic Press, pp. 445-485.
11. Ioannidis, M., et al.: 1996, Statistical analysis of the porous microstructure as a method for estimating reservoir permeability, Journal of Petroleum Science & Engineering 16, 251-261.
12. Journel, A.: 1992, Geostatistics: roadblocks and challenges, in A. Soares (ed.), Geostatistics-Troia 1992, Vol. 1, Kluwer Academic Publications, pp. 213-224.
13. Lantuejoul, C.: 2002, Geostatistical Sumulation: Models and Algorithms, Springer-Verlag, Berlin, Germany.
14. Maharaja, A.: 2008, Tigenerator: Object-based training image generator, Computers & Geosciences 34(12), 1753-1761.
15. Mitchell, M.: 1998, An Introduction to Genetic Algorithms, Academic Press.
16. Okabe, H. and Blunt, M. J.: 2005, Pore space reconstruction using multiple-point statistics, Journal of Petroleum Science & Engineering 46, 121-137.
17. Pilotti, M.: 2000, Reconstruction of classic porous media, Transport in Porous Media 41(3), 359-364.
18. Quiblier, J.: 1984, A new three-dimensional modeling technique for studying porous media, Journal of Colloid and Interface Science 1, 84-102.
19. Remy, N., et al.” 2009, Applied Geostatistics with SGeMS: A User's Guide, Cambridge University Press.
20. Strebelle, S.: 2000, Sequential simulation drawing structures from training images, PhD thesis, Stanford University, Stanford, Calif.
21. Tomutsa, L. and Radmilovic, V.: 2003, Focused ion beam assisted three-dimensional rock imaging at submicron-scale, International Symposium of the Society of Core Analysis.
22. Yeong, C. and Torquato, S.: 1998, Reconstructing random media ii. Three dimensional media from two-dimensional cuts, Physical Review E 58(1), 224-233.
23. Zhang, T.: 2006, Filter-based Training Pattern Classification for Spatial Patter Simulation, PhD thesis, Stanford University, Stanford, Calif.
24. Zhang, T., et al.: 2008, A statistical information reconstruction method of images based on multiple-point geostatistics integrating soft data with hard data, International Symposium on Computer Science and Computational Technology, Vol. 1, pp. 573-578.
25. Zhang, T., et. al..” 2009, Porous media reconstruction using a cross-section image and multiple-point geostatistics, International Conference on Advanced Computer Control, Singapore, Vol. 1, pp. 24-29.

1. A method for modeling a reservoir comprising:
a. receiving and loading data;
b. creating a 3D grid with a plurality of layers;
c. generating a 2D grid for each layer in sequence;
d. reconstructing or simulating a 2D image for a first layer;
e. sampling data from the 2D image on the first layer;
f. sampling data from the 2D grid for all other layers;
g. setting sampled data as hard data;
h. performing a filter based simulation to condition the hard data; and
i. copying the filter based simulation from the 2D grid to the 3D grid.

2. A method for modeling a reservoir comprising:
a. receiving and loading data;
b. creating a 3D grid with a plurality of layers;
c. generating a 2D grid for each layer in sequence;
d. getting target facies proportions;
e. sampling the data from the 2D grid, wherein the sampling is a point sampling, a geobody sampling or a hybrid sampling;
f. performing a single normal equation simulation to condition the data; and
g. copying the SNESIM based simulation from the 2D grid to the 3D grid.
